(19) United States
(12) Patent Application Publication
(10) Pub. No.: US 2021/0295353 A1
(43) Pub. Date: Sep. 23, 2021

(54) ELECTRONIC APPARATUS AND CONTROLLING METHOD THEREOF

(71) Applicant: SAMSUNG ELECTRONICS CO., LTD., Suwon-si (KR)

(72) Inventors: Sangmin LEE, Suwon-si (KR); Yongkuk You, Suwon-si (KR)

(73) Assignee: SAMSUNG ELECTRONICS CO., LTD., Suwon-si (KR)

(21) Appl. No.: 17/143,708

(22) Filed: Jan. 7, 2021

(30) Foreign Application Priority Data
Mar. 18, 2020 (KR) 10-2020-0033486

(51) Int. Cl. G06Q 30/02; G06Q 40/04; H04L 29/08; H04L 9/06

(52) U.S. Cl. CPC G06Q 30/02; G06Q 40/04; H04L 2209/38; H04L 9/0643; H04L 67/104

(57) ABSTRACT

An electronic apparatus includes a communication interface; a memory; and a processor. The processor is configured to, based on a content stored in the memory being transmitted to an external device, generate transaction information including transmission information of the content, transmit the transaction information to a block chain network through the communication interface, based on receiving a verification completion result regarding the transaction information through the block chain network, add the transaction information to a block chain of the block chain network based on the verification completion result, and receive reward information from another electronic apparatus included in the block chain network as a reward for a transmission of the content.

### CROSS-REFERENCE TO RELATED APPLICATION(S)

This application is based on and claims priority under 35 U.S.C. § 119 to Korean Patent Application No. 10-2020-0033486, filed on Mar. 18, 2020, in the Korean Intellectual Property Office, the disclosure of which is incorporated by reference herein in its entirety.

### BACKGROUND

### 1. Field

The disclosure relates to an electronic apparatus and a controlling method thereof and more particularly, to an electronic apparatus that is included in a block chain network to share contents with another electronic apparatus and an electronic apparatus that provides a reward to an electronic apparatus which shares contents with.

### 2. Description of Related Art

Recently, with the development of electronic technology and Internet technology, users share contents through peer to peer (P2P) streaming. P2P streaming is a content sharing method that combines peer to peer (P2P) and streaming.

P2P is a data sharing method in which a plurality of individual users directly exchange data without going through an intermediary, and streaming is a method in which an electronic apparatus downloads a music file or a video file and plays the file without storing the file in the electronic apparatus while the electronic apparatus is connected to the Internet.

In other words, the P2P streaming service is performed as the electronic apparatus included in the P2P network transmits a content to another electronic apparatus in the P2P network and another electronic apparatus plays the received content in real time.

In the P2P streaming service, since one electronic apparatus downloads a content from a server and provides the downloaded content to a plurality of P2P nodes, the server can reduce the traffic load, and electronic apparatuses corresponding to each P2P node can receive at high speed.

Accordingly, in the P2P streaming service, the size, performance, maintenance capability, and sales of the P2P streaming network may vary depending on the number of electronic apparatuses that provide contents to the P2P streaming network. In other words, in the P2P streaming network, the more the electronic apparatuses that upload a large amount of contents, the more advantageous it is, so securing a large number of nodes that upload a lot of contents is important.

In the meantime, recently, there is an attempt to provide a block chain-based P2P streaming service by combining a P2P streaming service with a block chain technology.

Block chain is a distributed computing technology in which data that is subject to management forms a chain in the form of small data called ‘a block’ and is distributed and stored in a plurality of electronic apparatuses so that no one can arbitrarily modify the data and any one can view the results of changes in the data. The contents or information on the contents stored in the block chain network is difficult to forge/modify, delete or change due to the above-described characteristics of the block chain.

Using the advantages of the block chain, in the block chain-based P2P service industry including a block chain-based P2P streaming service, there are increasing attempts to manage contents and transmission information of the contents as a block to manage the transmission information of the contents transparently, and by inducing content providers who upload contents to actively provide contents to other electronic apparatuses in the block chain-based P2P network, to activate and maintain performance of the block chain-based P2P network.

### SUMMARY

Provided is a method of activating and maintaining a block chain-based P2P network by providing a reward to an electronic apparatus that provides contents on the block chain-based P2P network.

Provided is an electronic apparatus that is included in a block chain-based P2P network to provide contents to other electronic apparatuses, generates transaction information related to content transmission and receives a reward according to the transaction information.

Provided is an electronic apparatus that is included in a block chain-based P2P network to verify transaction information received from the block chain network and provides reward information to an electronic apparatus that generates transaction information according to the result of verification.

Additional aspects will be set forth in part in the description which follows and, in part, will be apparent from the description, or may be learned by practice of the presented embodiments.

In accordance with an aspect of the disclosure, an electronic apparatus included in a block chain network includes a communication interface, a memory and a processor configured to, based on a content stored in the memory being transmitted to an external device, generate transaction information including transmission information of the content, and transmit the transaction information to a block chain network through the communication interface, and the processor is configured to, based on receiving a verification completion result regarding the transaction information through the block chain network, add the transaction information to a block chain of the block chain network based on the verification completion result, and receive reward information from another electronic apparatus included in the block chain network as a reward for transmission of the content.

In accordance with an aspect of the disclosure, an electronic apparatus included in a block chain network includes a communication interface, a memory and a processor configured to receive through the communication interface transaction information generated as a first electronic apparatus included in the block chain network transmits a content to a second electronic apparatus, and the processor is configured to: verify validation of the transaction information to determine whether the content transmission has been performed from the first electronic apparatus to the second electronic apparatus, and based on determining that the content has been transmitted from the first electronic apparatus to the second electronic apparatus, provide reward information stored in the memory to the first electronic apparatus.

In accordance with an aspect of the disclosure, a controlling method of an electronic apparatus included in a block chain network includes, based on a content being transmitted to an external device, generating transaction information including transmission information of the content, transmitting the transaction information to the block chain network, based on receiving a verification completion result regarding the transaction information through the block chain network, adding the transaction information to a block chain of the block chain network based on the verification completion result, and receiving reward information from another electronic apparatus included in the block chain network as a reward for transmission of the content.

In accordance with an aspect of the disclosure, a controlling method of an electronic apparatus included in a block chain network includes receiving transaction information as a first electronic apparatus included in the block chain network transmits a content to a second electronic apparatus, verifying validation of the transaction information, determining whether the content transmission has been performed from the first electronic apparatus to the second electronic apparatus, and based on determining that the content has been transmitted from the first electronic apparatus to the second electronic apparatus, providing reward information to the first electronic apparatus.

In accordance with an aspect of the disclosure, a non-transitory computer-readable recording medium including a program for executing a controlling method of an electronic apparatus included in a block chain network includes, based on a content being transmitted to an external device, generating transaction information including transmission information of the content, transmitting the transaction information to the block chain network, based on receiving a verification completion result regarding the transaction information through the block chain network, adding the transaction information to a block chain of the block chain network based on the verification completion result, and receiving reward information from a node included in the block chain network as a reward for transmission of the content.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a view provided to schematically explain a block chain-based P2P content sharing system according to an embodiment;

FIG. 2 is a block diagram provided to explain configuration of an electronic apparatus that provides contents according to an embodiment;

FIG. 3 is a sequence view provided to explain a process in which an electronic apparatus receives reward information according to transmission of a content according to an embodiment;

FIG. 4 is a block diagram provided to explain configuration of an electronic apparatus that provides reward information according to an embodiment;

FIG. 5 is a view provided to explain an electronic apparatus that performs verification and consensus regarding transaction information according to an embodiment;

FIG. 6 is a flowchart provided to explain a method in which an electronic apparatus provides reward information according to an embodiment;

FIG. 7 is a flowchart provided to explain a method in which an electronic apparatus receives reward information according to an embodiment; and

FIG. 8 is a flowchart provided to explain a method in which an electronic apparatus provides reward information according to an embodiment.

### DETAILED DESCRIPTION

Before describing the present disclosure in detail, the drafting method of the present specification and drawings will be explained.

General terms that are currently widely used were selected as terms used in embodiments of the disclosure in consideration of functions in the disclosure, but may be changed depending on the intention of those skilled in the art or a judicial precedent, an emergence of a new technique, and the like. In addition, in a specific case, terms arbitrarily chosen by an applicant may exist. In this case, the meaning of such terms may be interpreted as defined in the present disclosure. If there is no specific definition, the corresponding terms may be interpreted based on the general contents of the present disclosure and common technical knowledge in the art.

Hereinafter, various embodiments will be described with reference to the accompanying drawings. However, this is not intended to limit the scope to the specific embodiment, and it should be understood to include all modifications, equivalents, and/or alternatives of embodiments of the present disclosure.

In addition, the same reference numerals or symbols in each drawing attached to the present disclosure indicate parts or components that perform substantially the same function. For convenience of description and understanding, different embodiments will be described using the same reference numerals or symbols. In other words, even if there are components having the same reference numeral are illustrated in a plurality of drawings, the plurality of drawing does not necessarily mean one embodiment.

In the present disclosure, a singular expression includes plural expressions unless the context clearly indicates otherwise. It will be understood that terms “include” or “have” used in the specification, specify the presence of features, numerals, steps, operations, components, parts mentioned in the specification, or a combination thereof, but do not preclude the presence or addition of one or more other features, numerals, steps, operations, components, parts, or a combination thereof.

In the present disclosure, the terms “have”, “may have”, “comprise”, or “may comprise” designate the presence of the corresponding features (e.g., numbers, functions, operations or components such as parts, etc.), but do not exclude the presence of additional features.

In the description, expressions such as “A or B”, “at least one of A and/or B”, or “one or more of A and/or B” may include all possible combinations of the items listed together. For example, “A or B”, “at least one of A and B”, or “at least one of A or B” may refer to the cases of (1) including at least one A, (2) including at least one B, or (3) including at least one A and at least one B.

Expressions “first”, “second”, or the like, used in the disclosure may indicate various components regardless of a sequence and/or importance of the components, will be used only in order to distinguish one component from the other components, and do not limit the corresponding components. For example, the order of use or arrangement of elements combined with ordinal numbers should not be limited by the numbers. If necessary, each ordinal number may be used interchangeably.

When it is mentioned that any component (for example, a first component) is (operatively or communicatively) coupled with/to or is connected to another component (for example, a second component), it is to be understood that any component is directly coupled with/to another component or may be coupled with/to another component through the other component (for example, a third component). On the other hand, when it is mentioned that any component (for example, a first component) is “directly coupled with/to” or “directly connected to” to another component (for example, a second component), it is to be understood that the other component (for example, a third component) is not present between any component and another component.

An expression “configured (or set) to” used in the disclosure may be replaced by an expression “suitable for”, “having the capacity to”, “designed to”, “adapted to”, “made to”, or “capable of” depending on a situation. A term “configured (or set) to” may not necessarily mean only “specifically designed to” in hardware. Instead, an expression “an apparatus configured to” may mean that the apparatus is “capable of” together with other apparatuses or components. For example, a “sub processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

Meanwhile, in the present disclosure, the term ‘user’ may refer to a person using an electronic apparatus or a device (e.g., an artificial intelligence electronic device) using an electronic apparatus.

Hereinafter, the present disclosure will be described in detail with reference to accompanying drawings.

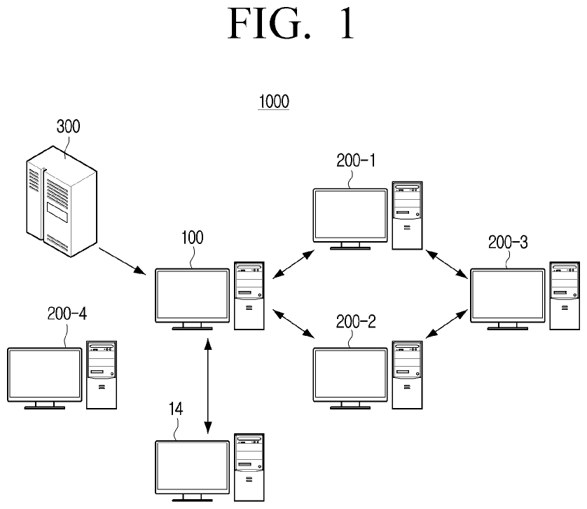

FIG. 1 is a view provided to schematically explain a block chain-based content sharing system according to an embodiment.

A block chain-based content sharing system 1000 in FIG. 1 may include a plurality of electronic apparatuses 14, 100, 200-1, 200-2, 200-3, and 200-4 and a content server 300. Since a block chain is premised on P2P communication, the block chain-based content sharing system 1000 according to an embodiment may include a P2P network for sharing contents and a block chain network for managing block chain information. In this case, according to an embodiment, the P2P network and the block chain network may be separate networks of different types or may be the same network.

The electronic apparatuses 14, 100, 200-1, 200-2, 200-3, and 200-4 may be connected to each other to operate as a ‘peer’ for P2P communication, and may share some or all of the contents. To this end, an application for sharing contents based on P2P communication may be installed in each of the plurality of electronic apparatuses 14, 100, 200-1, 200-2, 200-3, and 200-4.

In the present disclosure, the contents refers to a broad concept including various information for digitally producing, processing and distributing text, code, voice, sound, image, video, etc. for playback on the electronic apparatuses 14, 100, 200-1, 200-2, 200-3, and 200-4 and the contents therein. In other words, the contents represent information that is produced with electrical/electronic signals or data and can be transformed into a form recognizable by a user visually or audibly. The contents may include text, audio, image, video or combination thereof.

Since the electronic apparatus 100 is directly connected to the electronic apparatus 14, the electronic apparatus 200-1 and the electronic apparatus 200-2, the electronic apparatus 100 may provide contents to the electronic apparatus 14, the electronic apparatus 200-1 and the electronic apparatus 200-2 or receive contents from the electronic apparatus 14, the electronic apparatus 200-2 and the electronic apparatus 200-2. Likewise, the electronic apparatus 200-1 or the electronic apparatus 200-2 may provide contents to the electronic apparatus 200-2, or may receive contents from the electronic apparatus 200-3. Meanwhile, when the electronic apparatus 200-4 requests contents from the electronic apparatus 100 or the electronic apparatus 100 requests contents from the electronic apparatus 100 and thus, the electronic apparatus 200-4 is connected to the electronic apparatus 100, the electronic apparatus 100 may share contents with the electronic apparatus 200-4.

In FIG. 1, the electronic apparatuses 14, 100, 200-1, 200-2, 200-3, and 200-4 are illustrated as desktop PCs, but are not limited thereto. The electronic apparatuses 14, 100, 200-1, 200-2, 200-3, and 200-4 may be various terminal devices capable of providing and receiving contents, such as notebook PC, tablet PC, TV, set-top box, console device, etc.

Referring to FIG. 1, the electronic apparatus 100 may provide all or a part of contents stored in the electronic apparatus 100 to the electronic apparatus 14. Specifically, the electronic apparatus 100 may receive a request for contents from the electronic apparatus 14 and provide the contents to the electronic apparatus 14. In this case, the electronic apparatus 100 may transmit all or a part of the contents to the electronic apparatus 14 in a packet unit, and the electronic apparatus 14 may receive packets of contents from the electronic apparatus 100.

In this case, the electronic apparatus 100 may be a heavy uploader in that the electronic apparatus 100 may provide contents not only to the electronic apparatus 14 but also to the electronic apparatus 200-1 and the electronic apparatus 200-2. In other words, the electronic apparatus 100 provides contents to a plurality of nodes in a P2P communication network. In the present disclosure, the heavy uploader refers to a node that shares contents with other nodes in a P2P communication network by uploading contents of more than a predetermined amount of data on the P2P communication network or an electronic apparatus corresponding to the node.

Meanwhile, the electronic apparatus 100 may receive contents from the content server 300 in order to provide the contents to other electronic apparatuses. Specifically, the electronic apparatus 100 may request contents from the content server 300, and the content server 300 may provide the contents to the electronic apparatus 100.

Meanwhile, the block chain-based content sharing system 1000 may form a block chain network that manages block information related to content sharing.

The block chain network refers to a system that operates in a manner in which a plurality of apparatuses disperse and possess data, generate blocks at a predetermined time unit and each apparatus perform verification. The block chain network may consist of a block chain application and a platform.

A block chain application for using a block chain network may be installed in each of the electronic apparatuses 14, 100, 200-1, 200-2, 200-3, and 200-4 in FIG. 1.

In the present disclosure, the feature that one apparatus included in a block chain network transmits or uploads transaction information to the block chain network means that the transaction information is recorded in the public ledger (block) that is released every predetermined time (e.g., every 5 minutes) on the block chain network to which a plurality of electronic apparatuses are connected. The transaction information represents transaction information between apparatuses included in the block chain network and in the present disclosure, the transaction information represents transmission/reception information of contents between electronic apparatuses included in the block chain network.

For example, if the electronic apparatus 100 transmits a content to the electronic apparatus 14, the electronic apparatus 100 may generate transaction information including information on the content transmission from the electronic apparatus 100 to the electronic apparatus 14, and transmit or upload the same to the block chain network.

The content transmission information is information related to the content transmission, and may include information on the content, the content transmission time, the apparatus that transmitted the content, the apparatus that received the content, and reward information according to the content transmission.

The electronic apparatus 100 and the electronic apparatuses 200-1, 200-2, 200-3, and 200-4 included in the block chain network may verify and agree on the validation of the transaction information uploaded by the electronic apparatus 100. Specifically, each of the electronic apparatuses 200-1, 200-2, 200-3, and 200-4 may receive and analyze the transaction information generated by the electronic apparatus 100. The electronic apparatus 100 and each of the electronic apparatuses 200-1, 200-2, 200-3, and 200-4 may determine integrity of the transaction information, and verify the validation of the information regarding contents included in the transaction information. If more than a predetermined number of electronic apparatuses among the electronic apparatus 100 and the electronic apparatuses 200-1, 200-2, 200-3, and 200-4 determine that the transaction information is valid, it can be determined that content transmission has been performed from the electronic apparatus 100 to the electronic apparatus 14.

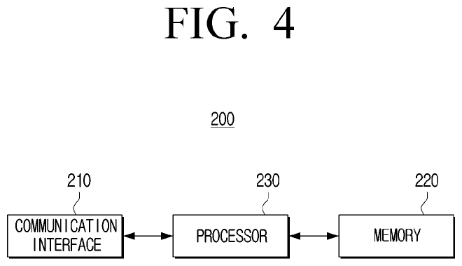

In this case, the electronic apparatuses 200-1, 200-2, 200-3, and 200-4 including the electronic apparatus 100 may be a consensus node of the block chain network. In the present disclosure, the consensus node represents a node that verifies and agrees on the validation of the transaction that occurs in the block chain network. The operation of the electronic apparatus corresponding to the consensus node will be described in detail with reference to FIGS. 4 to 6.

When the electronic apparatus 100 completes verification and consensus regarding the uploaded transaction information, the electronic apparatus 100 may receive reward information as a reward for content transmission to the electronic apparatus 14 from the block chain network. In this case, the reward information may include block information including cryptocurrency (or virtual currency).

As shown above, the electronic apparatus 100 included in the block chain-based content sharing system 1000 provides contents to other electronic apparatuses and receives reward information as a reward for providing the contents and thus, the electronic apparatus 100 may upload contents actively in the block chain-based P2P content sharing system. Accordingly, the number of electronic apparatuses receiving contents increases, and the block chain-based content sharing system 1000 can be activated and maintained.

Hereinafter, the electronic apparatus 100 providing contents on the above-described block chain-based content sharing system 1000 and an electronic apparatus 200 providing reward information according to provision of contents will be described in greater detail.

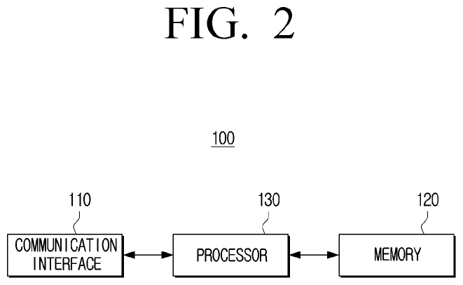

FIG. 2 is a block diagram provided to explain configuration of an electronic apparatus that provides contents according to an embodiment. Referring to FIG. 2, the electronic apparatus 100 includes a communication interface 110, a memory 120 and a processor 130.

The communication interface 110 may be connected to an external electronic apparatus directly/indirectly based on a network that is implemented through wired communication and/or wireless communication. The electronic apparatus 100 may be connected to at least one of a plurality of electronic apparatuses included in the block chain-based content sharing system 1000 through the communication interface 110. In addition, the electronic apparatus 100 may be connected to the content server 300 through the communication interface 110.

The network may be Personal Area Network (PAN), Local Area Network (LAN), Wide Area Network (WAN), etc. depending on the area or size, and may be Intranet, Extranet, Internet, etc. depending on the openness of the network.

Here, the wireless communication may include at least one of communication methods such as long-term evolution (LTE), LTE Advance (LTE-A), 5th Generation (5G) mobile communication, code division multiple access (CDMA), wideband CDMA (WCDMA), universal mobile telecommunications system (UMTS), Wireless Broadband (WiBro), Global System for Mobile Communications (GSM), Time Division Multiple Access (DMA), WiFi, WiFi Direct, Bluetooth, near field communication (NFC), ZigBee, and the like.

The wired communication may include at least one of communication methods such as Ethernet, optical network, Universal Serial Bus (USB), ThunderBolt), and the like. Here, the communication interface 110 may include a network interface or a network chip according to the above-mentioned wired/wireless communication methods. Meanwhile, the communication methods are not limited to the above examples, and may include communication methods which newly emerge according to the development of technology.

The memory 120 is configured to store an Operating System (OS) for controlling the overall operations of the components of the electronic apparatus 100 and at least one instruction or data related to the components of the electronic apparatus 100.

The processor 130 may perform operations according to an embodiment which will be described later by executing at least one instruction stored in the memory 120.

The memory 120 is configured to store various programs, data, etc. required for the operations of the electronic apparatus 100. The memory 120 may be implemented as a non-volatile memory, a volatile memory, a flash memory, a hard disk drive (HDD), a solid state drive (SSD), etc. The memory 120 can be accessed by the processor 130, and reading/recording/correction/deletion, etc. of data by the processor 130 may be performed. In this disclosure, the term ‘a memory’ may include the memory 120, a ROM (not shown) inside the processor 130, or a memory card (not shown) (e.g., a micro SD card, a memory stick) mounted on a RAM (not shown) or the electronic apparatus 100.

The memory 120 may store various block information constituting blocks including transaction information and reward information shared on the block chain network. In addition, the memory 120 may store contents to be shared with other electronic apparatuses on the P2P network. Further, the memory 120 may store an application for sharing contents with one or more electronic apparatuses on the P2P network, an application for sharing block information with one or more electronic apparatuses on the block chain network, and the like.

The processor 130 may be electrically connected to the memory 120 to control the overall operations and functions of the electronic apparatus 100. For example, the processor 130 may drive the operating system or application programs to control hardware or software components connected to the processor 130 and perform various data processing and operations. In addition, the processor 130 may load instructions or data received from at least one of other components onto a volatile memory and process the same, and store various data in a non-volatile memory.

To this end, the processor 130 may be implemented as a dedicated processor (e.g., an embedded processor) for performing the corresponding operations or a general-purpose processor (e.g., a Central Processing Unit (CPU)) or an application processor) capable of performing the corresponding operations by executing one or more software programs stored in a memory device.

In the present disclosure, the processor 130 may be implemented as a digital signal processor (DSP) processing a digital signal, a microprocessor, or a time controller (TCON). However, the processor 130 is not limited thereto, but may include one or more of a central processing unit (CPU), a micro controller unit (MCU), a micro processing unit (MPU), a controller, an application processor (AP), a graphics-processing unit (GPU) or a communication processor (CP), or an ARM processor, or may be defined by these terms. In addition, the processor 130 may be implemented as a system-on-chip (SoC) or a large scale integration (LSI) in which a processing algorithm is embedded or may be implemented in a field programmable gate array (FPGA) form.

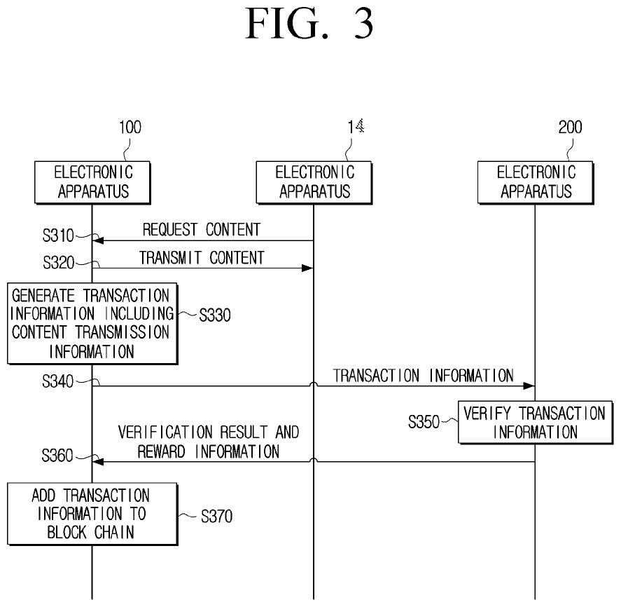

Hereinafter, the specific operations of the electronic apparatus 100 having the above-mentioned configuration will be described with reference to FIG. 3.

FIG. 3 is a sequence view provided to explain a process in which an electronic apparatus receives reward information according to transmission of a content according to an embodiment.

The electronic apparatus 100 stores a content in the memory 120.

The content stored in the memory 120 may be a content generated using an input interface such as a camera (not shown) and a microphone (not shown) or a content provided from the content server 300.

If the electronic apparatus 100 requests a content, the content server 300 may provide the content to the electronic apparatus 100.

According to an embodiment, the content server 300 may provide a content to the electronic apparatus 100 under certain conditions. For example, the content server 300 may determine whether the electronic apparatus 100 is a heavy uploader, and may provide a content to the electronic apparatus 100 only when the electronic apparatus 100 is a heavy uploader.

In order to determine whether the electronic apparatus 100 is a heavy uploader, that is, in order to determine whether the electronic apparatus 100 is capable of providing a large amount of contents to a plurality of electronic apparatuses, the content server 300 may request hardware information such as a memory capacity, a storage capacity and a network capacity of the electronic apparatus 100 from the electronic apparatus 100. The content server 300 may receive the hardware information of the electronic apparatus 100 from the electronic apparatus 100, and provide a content to the electronic apparatus 100 only when the hardware capacity of the electronic apparatus 100 satisfies predetermined conditions. However, this is only an example, and the content server 300 may receive information such as a content provision period or amount of contents to be transmitted from the electronic apparatus 100, and provide a content to the electronic apparatus 100 according to the received content provision period or amount of contents to be transmitted.

The electronic apparatus 100 may receive a content request from the electronic apparatus 14 (S310), and provide the content requested by the electronic apparatus 14 to the electronic apparatus 14 (S320). Specifically, the processor 130 may receive a content request from the electronic apparatus 14 through the communication interface 110, search the content requested by the electronic apparatus 14 among contents stored in the memory 120, and provide the content to the electronic apparatus 14 through the communication interface 110.

To this end, the processor 130 may provide information on the contents stored in the memory 120 to the block chain-based content sharing system 1000. The content transmission information is information related to transmission of content, and may include information regarding the content, the content transmission time, the identification number of the device that transmitted the content, the identification number of the device that received the content, and reward information according to the transmission of the content. For example, if the processor 130 transmits content A to the electronic apparatus 14, the content transmission information may include the content A, the transmission time of 18:09:24, the identification number (e.g., IP address) of the electronic apparatus 100, the identification number (e.g., IP address) of the electronic apparatus 14, the reward information (e.g., cryptocurrency 10 BTC), and the like.

The electronic apparatus 14 may request a content from the electronic apparatus 100 based on the content information stored in the electronic apparatus 100.

When the content is transmitted to the electronic apparatus 14, the processor 130 may generate transaction information including transmission information of the content (S330). Specifically, the processor 130 may generate transaction information including information regarding the transmitted content (e.g., content name, content identification number, content creator, etc.), the content transmission time, information regarding the electronic apparatus 100 that provides the content, and information regarding the electronic apparatus 14 that receives the content.

In this case, the processor 130 may refer to the output of the previous transaction as the input of a new transaction. For example, if the electronic apparatus 100 transmits content A to the electronic apparatus 200-1 and then, transmits content B to the electronic apparatus 14, the processor 130 may generate transaction information regarding the content A, and refer to the transaction information regarding the content A as the input of the transaction information regarding the content B.

Meanwhile, according to another embodiment, the processor 130 may receive transaction information related to a content from a manager device that manages a block chain network, and generate transaction information including transmission information of the content based on this. Here, the manager device is one of nodes included in the block chain network, and may be one of consensus nodes that generate and verify block information and play a consensus role in the block chain network. In other words, the manager device may be one of the electronic apparatuses 200-1, 200-2, 200-3, and 200-4 included in the block chain network. In this case, the operator of the content server 300 that provides contents may also operate the block chain network manager device separately from the content server 300.

The processor 130 may receive a content from the content server 300 and receive transaction information related to the content from a manager device that manages the block chain network. If the processor 130 transmits a content to the electronic apparatus 14, the processor 130 may generate transaction information by adding transmission information of the content to the electronic apparatus 14 to the transaction information related to the content received from the manager device.

The processor 130 may transmit the generated transaction information to the block chain network through the communication interface 110 (S340). Specifically, the processor 130 may transmit the generated transaction information to the electronic apparatus 200 corresponding to a consensus node of the block chain network. Here, the electronic apparatus 200 may be one of the electronic apparatuses 200-1, 200-2, 200-3, and 200-4 in FIG. 1.

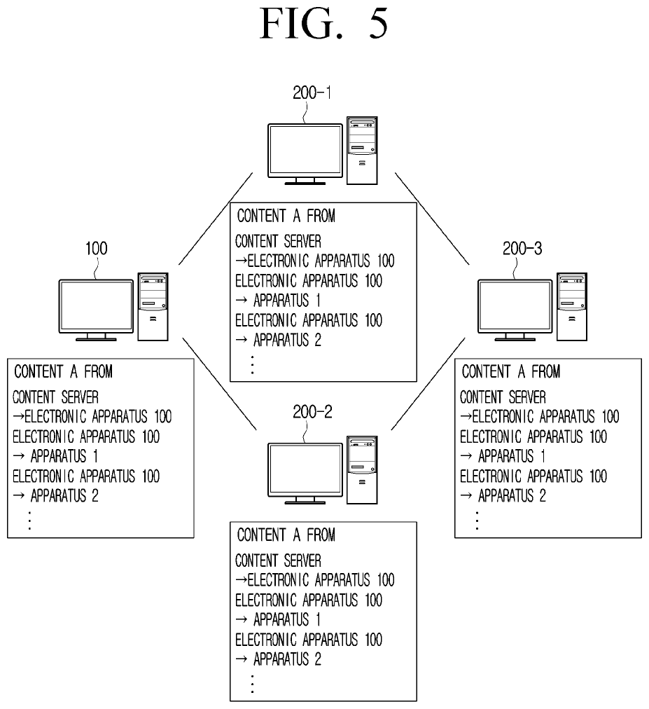

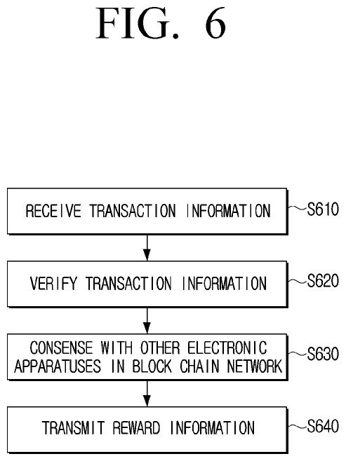

The electronic apparatus 200 that receives the transaction information from the processor 130 may perform verification and consensus regarding the transaction information. The process where the electronic apparatus 200 performs verification and consensus regarding the transaction information will be described in detail with reference to FIGS. 5 and 6.

When receiving a verification completion result regarding the transaction information through the block chain network, the processor 130 may add the transaction information to the block chain network based on the verification completion result. Here, the block chain represents information where blocks generated by transaction information are connected through chains.

On the block chain-based content sharing system 1000 of the present disclosure, the block chain may store content transmission/reception history between electronic apparatuses, information on contents transmitted/received between electronic apparatuses (e.g., contents, content identification number, content creator, etc.), electronic apparatuses (e.g., content providing apparatus, content receiving apparatus), information related to reward information of the block chain network regarding each of the electronic apparatuses, etc. as block information.

The processor 130 may receive reward information from the electronic apparatus 200 as a reward for transmission of content (S360). In the present disclosure, the reward information is block information related to a reward, and may include cryptocurrency (or virtual currency). The electronic apparatus 200 that provides reward information to the electronic apparatus 100 may be an electronic apparatus corresponding to one of consensus nodes of the block chain network.

The processor 130 may receive reward information based on information regarding a content included in transaction information. Specifically, the processor 130 may receive reward information in proportion to the amount of contents transmitted. Alternatively, the processor 130 may receive reward information based on the popularity, quality and disclosure time of the content. For example, if the content is popular, the quality is good, or the content is recently published, the processor 130 may receive a large amount of reward information.

As such, the electronic apparatus 100 receives a reward according to transmission of contents through the block chain-based content sharing system 1000 and thus, provides contents to other electronic apparatuses in the network more actively. Accordingly, the block chain-based content sharing system may be more activated and stabilized.

FIG. 4 is a block diagram provided to explain configuration of an electronic apparatus that provides reward information according to an embodiment. Referring to FIG. 4, the electronic apparatus 200 includes a communication interface 210, a memory 220 and a processor 230.

The communication interface 210, the memory 220 and the processor 230 of the electronic apparatus 200 are the same components as the communication interface 110, the memory 120 and the processor 130 of the electronic apparatus 100 and thus, among the features of the communication interface 210, the memory 220 and the processor 230 of the electronic apparatus 200, those overlapped with the features of the communication interface 110, the memory 120 and the processor 130 of the electronic apparatus 100 in FIG. 2 will be omitted.

The communication interface 210 is configured for the electronic apparatus 200 to perform communication with other electronic apparatuses in the block chain-based content sharing system 1000. The electronic apparatus 200 may be connected to at least one of a plurality of electronic apparatuses included in the block chain-based content sharing system 1000 through the communication interface 210.

The memory 220 may store various block information constituting blocks including transaction information and reward information, which are shared on the block chain network. In addition, the memory 220 may store a content to be shared with other electronic apparatuses. Further, the memory 220 may store an application for sharing contents with one or more electronic apparatuses on the P2P network, an application for sharing block information with one or more electronic apparatuses on the block chain network, and the like.

The processor 230 may be electrically connected to the memory 220 and control the overall operations and functions of the electronic apparatus 100.

When receiving transaction information which is generated as the first electronic apparatus transmits a content to the second electronic apparatus, the processor 130 may verify validation of the received transaction information to determine whether transmission of the content is performed from the first electronic apparatus to the second electronic apparatus. Here, the first electronic apparatus is an electronic apparatus that provides contents and may be the electronic apparatus 100 of FIG. 1, and the second electronic apparatus is an electronic apparats that receives contents and may be the electronic apparatus 14 of FIG. 1.

If it is determined that transmission of the content is performed from the first electronic apparatus to the second electronic apparatus based on the transaction information, the processor 230 may provide reward information stored in the memory 220 to the first electronic apparatus.

Hereinafter, the method where the electronic apparatus 200 provides reward information will be described in detail with reference to FIGS. 5 and 6.

FIG. 5 is a view provided to explain an electronic apparatus that performs verification and consensus regarding transaction information according to an embodiment.

FIG. 5 illustrates a plurality of electronic apparatuses 100, 200-1, 200-2, and 200-3. Here, the electronic apparatus 200 may be one of the electronic apparatuses 200-1, 200-2, 200-3.

As illustrated in FIG. 5, one of the electronic apparatus 100, 200-1, 200-2, 200-3 are interconnected on the block chain network. Here, the electronic apparatuses 100, 200-1, 200-2, 200-3 may correspond to consensus nodes of the block chain network. In the present disclosure, the consensus node refers to a node that generates block information including transaction information, and verifies and agrees on the integrity of a transaction occurring in the block chain network through a consensus algorithm. In this case, various consensus algorithms such as Proof of Contribution (PoC), Proof of Work (PoW) and Proof of Stake (PoS) may be used.

The consensus node may be selected by a manager of the block chain network. In the present disclosure, the manager of the block chain network may be one of a plurality of consensus nodes included in the block chain network.

The manager of the block chain network may select a node with the most block information related to asset (e.g., virtual currency and cryptocurrency) among the plurality of nodes included in the block chain network as a consensus node, or a node that contributed to the block chain network by performing activities exceeding a predetermined standard may be a consensus node.

Referring to FIG. 5, each of the electronic apparatuses 100, 200-1, 200-2, and 200-3 corresponding to the consensus node may have a ledger. In the ledger included in each of the electronic apparatuses 100, 200-1, 200-2, 200-3, information on all transactions occurring in the block chain-based content sharing system 1000 may be described. For example, if the electronic apparatus 100 receives content A from the content server 300 and transmits content A to apparatus 1 and apparatus 2, among the electronic apparatuses 200-1, 200-2, and 200-3, the history of such transmission/reception of content A of the electronic apparatus 100 may be recorded in the electronic apparatuses 100, 200-1, 200-2, and 200-3. Specifically, if the electronic apparatus 100 transmits a content A to the apparatus 1, the electronic apparatus 100 may generate transaction information related to the transmission of the content to the apparatus 1, and transmit the transaction information to the block chain network. Subsequently, the electronic apparatuses 200-1, 200-2, and 200-3 may receive the transaction information related to the transmission of the content to the apparatus 1 from the electronic apparatus 100 through the block chain network and record the received transaction information in the ledger. As such, since the transaction information is transmitted through the block chain network, the ledger of the electronic apparatuses 100, 200-1, 200-2, 200-3 included in the block chain network includes the same transaction information.

The electronic apparatuses 100, 200-1, 200-2, 200-3 may verify and agree on the validation of the transaction included in the ledger. In addition, the electronic apparatuses 100, 200-1, 200-2, 200-3 may provide reward information to the electronic apparatus 100 that has transmitted the transaction information according to a result of the verification and agreement.

In this regard, FIG. 6 is a flowchart provided to explain a method in which an electronic apparatus provides reward information according to an embodiment.

The electronic apparatus 200 may receive transaction information through the communication interface 210 (S610). Specifically, the processor 230 may receive transaction information which is generated as the first electronic apparatus included in the block chain network transmits a content to the second electronic apparatus.

The processor 230 may verify validation of the received transaction information (S620). Specifically, the processor 230 may determine whether the transmission of the content from the first electronic apparatus to the second electronic apparatus is valid (integrity) by verifying validation of the transaction information.

The processor 230 may perform consensus with other electronic apparatuses corresponding to consensus nodes in the block chain network in order to determine the integrity of the transaction information (S630).

Specifically, the processor 230 may transmit a verification result regarding the transaction information to the block chain network through the communication interface 210. In this case, not only a result of verification performed by the electronic apparatus 200 but also a result of verification regarding the transaction information performed by the electronic apparatuses corresponding to other consensus nodes in the block chain network may be shared on the block chain network.

The processor 230 may receive a verification result regarding the transaction information from at least one of the other electronic apparatuses corresponding to the consensus nodes, and determine that the content has been transmitted from the first electronic apparatus to the second electronic apparatus based on the result of verification performed by the processor 230 and the result of verification received from the other electronic apparatuses.

If the verification result received from each of the electronic apparatuses corresponding to the consensus odes of the block chain network satisfies a predetermined condition, the processor 230 may perform consensus regarding the transaction. For example, if more than ⅔ of the electronic apparatuses among the plurality of electronic apparatuses corresponding to the consensus nodes verifies that the transaction information is valid, the processor 230 may agree that the transaction information is valid.

If it is determined that the transmission of the content from the first electronic apparatus to the second electronic apparatus is valid based on the verification and consensus regarding the transaction information, the processor 230 may transmit reward information stored in the memory 220 to the first electronic apparatus.

Specifically, the processor 230 may identify that the content provider is the first electronic apparatus using information on the first electronic apparatus included in the transaction information, and provide reward information to the first electronic apparatus.

The processor 230 may identify the capacity of the content transmitted from the first electronic apparatus to the second electronic apparatus using the capacity of the content transmitted to the second electronic apparatus included in the transaction information, and provide reward information in proportion to the capacity of the transmitted content. However, this is only an example, and the processor 230 may provide reward information to the first electronic apparatus in consideration of the popularity, quality and disclosure time of the content.

As such, by providing reward information to the electronic apparatus that has provided a content according to the content provision, the electronic apparatus 200 may encourage the content providing apparatus to provide a large amount of contents in the block chain-based content sharing system, and induce an increase in the number of apparatuses providing and receiving contents, activating and developing the block chain-based content sharing system.

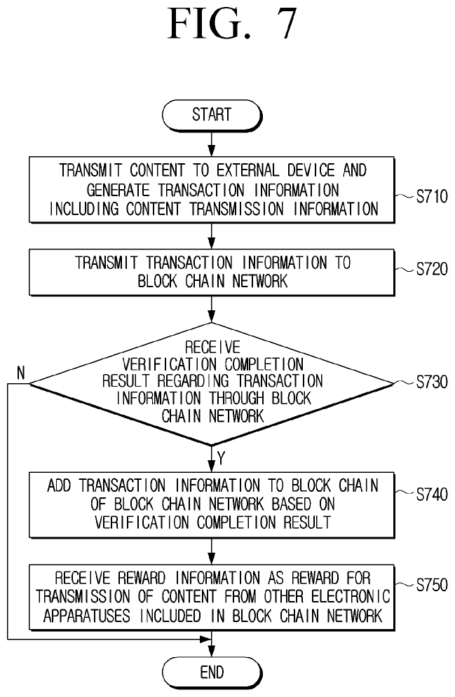

FIG. 7 is a flowchart provided to explain a method in which an electronic apparatus receives reward information according to an embodiment.

Firstly, a content is transmitted to an external apparatus, and transaction information including transmission information of the content is generated (S710). Specifically, after transmitting the content stored in the electronic apparatus 100 to the external apparatus, transaction information including information on the transmitted content (e.g., content name, content identification number, content creator, etc.), content transmission time, information on the electronic apparatus that provides the content, and information on the electronic apparatus 14 that receives the content may be generated.

Meanwhile, a content may be received from a content server. In this case, transaction information related to the content may be received from a manager device that manages the block chain network, and transaction information including the transmission information of the content may be generated based on this. Here, the manager device is one of the nodes included in the block chain network, and may be one of the consensus nodes that generate and verify block information and plays a consensus role in the block chain network.

The transaction information is transmitted to the block chain network (S720). Specifically, the generated transaction information may be transmitted to the electronic apparatus 200 corresponding to the consensus node of the block chain network.

The electronic apparatus 200 that has received the transaction information may verify and agree on the transaction information, and transmit a verification completion result regarding the transaction information to the electronic apparatus 100.

When a verification completion result regarding the transaction information is received through the block chain network (S730-Y), the transaction information may be added to the block chain network based on the verification completion result (S740). Here, the block chain represents information in which blocks generated by transaction information are connected through chains. The block chain may store content transmission/reception history between electronic apparatuses, information on contents transmitted/received between electronic apparatuses (e.g., contents, content identification number, content creator, etc.), electronic apparatuses (e.g., content providing apparatus, content receiving apparatus), information related to reward information of the block chain network regarding each of the electronic apparatuses, etc. as block information.

Subsequently, reward information is received from other electronic apparatuses included in the block chain network as a reward for transmission of the content (S750). Here, the reward information is block information related to the reward, and may include cryptocurrency (or virtual currency). The electronic apparatus 200 that provides reward information to the electronic apparatus 100 may be an electronic apparatus corresponding to one of the consensus nodes of the block chain network.

In this case, reward information can be received based on information on the content included in the transaction information. Specifically, reward information can be received in proportion to the amount of the transmitted contents.

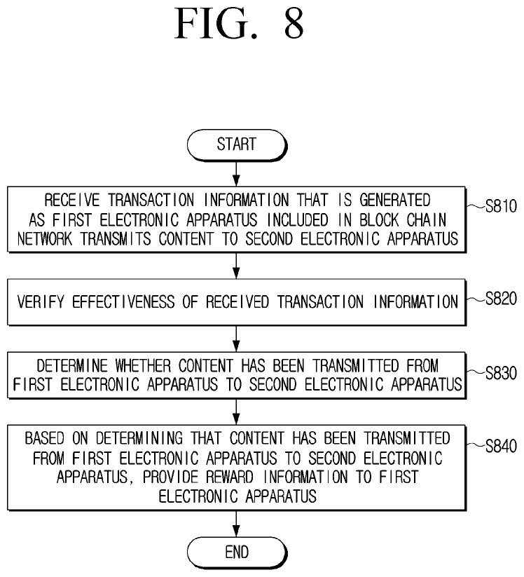

FIG. 8 is a flowchart provided to explain a method in which an electronic apparatus provides reward information according to an embodiment.

Firstly, transaction information that is generated as the first electronic apparatus included in the block chain network transmits a content to the second electronic apparatus is received (S810).

Subsequently, by verifying validation of the received transaction information (S820), it is determined whether transmission of the content is performed from the first electronic apparatus to the second electronic apparatus (S830).

In this case, in order to determine integrity of the transaction information, consensus can be performed with other electronic apparatuses corresponding to the consensus nodes in the block chain network.

Specifically, a validation result regarding transaction information is received from at least one of other electronic apparatuses corresponding to the consensus nodes, and based on the result of the validation verification performed by the electronic apparatus 100 and the validation verification result received from other electronic apparatuses, it may be determined that the content is transmitted from the first electronic apparatus to the second electronic apparatus. For example, if more than ⅔ of the electronic apparatuses among the plurality of electronic apparatuses corresponding to the consensus nodes verify that the transaction information is valid, it can be agreed that the transaction information is valid.

If it is determined that the content is transmitted from the first electronic apparatus to the second electronic apparatus based on the result of the verification and consensus, reward information is provided to the first electronic apparatus (S840).

Specifically, using information on the first electronic apparatus included in the transaction information, it can be identified that the content provider is the first electronic apparatus, and reward information can be provided to the first electronic apparatus. For example, using the capacity of the content transmitted to the second electronic apparatus included in the transaction information, the capacity of the content transmitted from the first electronic apparatus to the second electronic apparatus can be identified, and reward information may be provided in proportion to the capacity of the transmitted content.

Meanwhile, the diverse operations described above that are performed through the electronic apparatus 100 or the electronic apparatus 200 may be performed through one or more electronic apparatuses through the controlling method or in the form of the operation method of the block chain network.

Meanwhile, the diverse embodiments described above may be implemented in a recording medium readable by a computer or a similar device using software, hardware, or a combination of software and hardware.

According to a hardware implementation, embodiments described in the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions.

In some cases, embodiments described in the specification may be implemented by the processor itself. According to a software implementation, embodiments such as procedures and functions described in the specification may be implemented by separate software modules. Each of the software modules may perform one or more functions and operations described in the specification.

Meanwhile, the computer instructions for performing processing operations in a user device or a manager device according to the above-described various embodiments of the present disclosure may be stored in a non-transitory computer-readable medium. The computer instructions stored such a non-transitory computer-readable medium are designed such that when executed by the processor of a specific device, the specific device performs the processing operations of the user device and/or manager device according to the above-described various embodiments.

The non-transitory computer-readable medium is not a medium that stores data for a while, such as a register, a cache, a memory, or the like, but means a medium that semi-permanently stores data and is readable by an apparatus. Specifically, the above-described various applications or programs may be stored and provided in a non-transitory readable medium such as a compact disc (CD), a digital versatile disc (DVD), a hard disc, a Blu-ray disc, a universal serial bus (USB), a memory card, a read only memory (ROM), or the like.

While certain embodiments have been particularly shown and described with reference to the drawings, embodiments are provided for the purposes of illustration and it will be understood by one of ordinary skill in the art that various modifications and equivalent other embodiments may be made from the disclosure. Accordingly, the true technical scope of the disclosure is defined by the technical spirit of the appended claims.

What is claimed is:

1. An electronic apparatus that shares contents, the electronic apparatus comprising:
a communication interface;
a memory; and
a processor configured to:
based on a content stored in the memory being transmitted to an external device, generate transaction information including transmission information of the content,
transmit the transaction information to a block chain network through the communication interface,
based on receiving a verification completion result regarding the transaction information through the block chain network, add the transaction information to a block chain of the block chain network based on the verification completion result, and
receive reward information from another electronic apparatus included in the block chain network as a reward for a transmission of the content.

2. The electronic apparatus as claimed in claim 1, wherein the processor is configured to:
based on receiving a content from a content server and receiving the transaction information related to the content from a manager device managing the block chain network, generate the transaction information including the transmission information of the content by adding the transmission information of the content to the transaction information related to the content.

3. The electronic apparatus as claimed in claim 1, wherein the processor is configured to:
generate the transaction information including at least one of information regarding the content, transmission time, information regarding the electronic apparatus, or information regarding an external device that receives the content.

4. An electronic apparatus included in a block chain network, the electronic apparatus comprising:
a communication interface;
a memory; and
a processor configured to:
receive, through the communication interface, transaction information generated as a first electronic apparatus included in the block chain network transmits a content to a second electronic apparatus,
verify validation of the transaction information to determine whether the content transmission has been performed from the first electronic apparatus to the second electronic apparatus, and
based on determining that the content has been transmitted from the first electronic apparatus to the second electronic apparatus, provide reward information stored in the memory to the first electronic apparatus.

5. The electronic apparatus as claimed in claim 4, wherein the processor is configured to identify that a content provider is the first electronic apparatus using information of the first electronic apparatus included in the transaction information, and provide the reward information to the identified first electronic apparatus.

6. The electronic apparatus as claimed in claim 5, wherein the processor is configured to identify a capacity of the content transmitted from the first electronic apparatus to the second electronic apparatus using a capacity of a content transmitted to the second electronic apparatus included in the transaction information, and provide the reward information to the first electronic apparatus in proportion to the identified capacity of the content.

7. The electronic apparatus as claimed in claim 4, wherein the processor is configured to:
receive a validation result regarding the transaction information from at least one electronic apparatus included in the block chain network; and
determine that the content has been transmitted from the first electronic apparatus to the second electronic apparatus based on a result of verification performed regarding the transaction information and the validation result received from the at least one electronic apparatus.

8. A controlling method of an electronic apparatus included in a block chain network, the controlling method comprising:
based on a content being transmitted to an external device, generating transaction information including transmission information of the content;
transmitting the transaction information to the block chain network;
based on receiving a verification completion result regarding the transaction information through the block chain network, adding the transaction information to a block chain of the block chain network based on the verification completion result; and
receiving reward information from another electronic apparatus included in the block chain network as a reward for a transmission of the content.

9. The controlling method as claimed in claim 8, further comprising:
receiving a content from a content server; and
receiving the transaction information related to the content from a manager device managing the block chain network,
wherein the generating the transaction information comprises generating the transaction information including the transmission information of the content by adding the transmission information of the content to the transaction information related to the content.

10. The controlling method as claimed in claim 8, wherein the generating the transaction information comprises generating the transaction information including at least one of information regarding the content, transmission time, information regarding the electronic apparatus, or information regarding an external device that receives the content.
